(19) United States
(12) Patent Application Publication
(10) Pub. No.: US 2009/0009627 A1
(43) Pub. Date: Jan. 8, 2009

(54) IMAGE PHOTOGRAPHING APPARATUS

(75) Inventors: Kyoung-jin AHN, Suwon-si (KR); Byeong-woo Yi, Incheon (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/018,351

(22) Filed: Jan. 23, 2008

(30) Foreign Application Priority Data
Jul. 2, 2007 (KR) 2007-66249

(51) Int. Cl. H04N 5/76

(52) U.S. Cl. 348/231.7

(57) ABSTRACT

An image photographing apparatus includes a main body including a lens unit, and a recording medium driving unit to drive a recording medium that records an image photographed through the lens unit, a recording medium cover openably attached to the main body of the image photographing apparatus to insert or to remove the recording medium to or from the recording medium driving unit, a locking unit to lock or unlock the recording medium cover, and a manual opening unit detachably attached to the main body of the image photographing apparatus to expose and allow the locking unit to be manually operated to remove the recording medium in a “no power” situation.

### CROSS-REFERENCE TO RELATED APPLICATIONS

This application claims priority under 35 U.S.C. § 119 (a) from Korean Patent Application No. 10-2007-0066249, filed on Jul. 2, 2007, in the Korean Intellectual Property Office, the disclosure of which is hereby incorporated herein in its entirety by reference.

### BACKGROUND OF THE INVENTION

1. Field of the Invention

The present general inventive concept relates to an image photographing apparatus to photograph an object and record an image generated from the photographed object onto a recording medium.

2. Description of the Related Art

An image photographing apparatus uses a variety of recording media to write still or moving images thereon. Some examples of such recording media include a recording tape, a built-in memory, a removable memory, or a recording disk such as a DVD disk which has been widely used recently.

An image photographing apparatus that uses disks like DVD as a recording medium generally includes a recording medium driving unit, a recording medium cover openably attached to the main body of the image photographing apparatus to allow insertion and removal of recording medium to and from the recording medium driving unit, and a locking unit to lock and unlock the recording medium cover.

A disk type of recording medium rotates at a high speed during image photographing. Accordingly, the recording medium may pop out through the cover and fall onto the ground, or even worse, hurt people nearby, if the cover is inadvertently opened during photographing. Therefore, for safety reasons, a locking unit of such an image photographing apparatus adopts a structure that is operable according to an electrical signal.

For example, a locking unit allows the recording medium cover to open only after the disk stops rotating, instead of the cover instantly opening in response to a user pressing the eject button. In order to achieve this, an electrically driven solenoid or motor is connected with the cover locking unit, and the solenoid or motor is driven a predetermined time after an input of an eject button pressing signal to release the locked state of the locking unit.

However, these electrically driven locking units have some drawbacks. That is, it is difficult and cumbersome to remove the recording medium when power is not supplied, like in the case of battery discharge or a disconnect from an external power source.

In the above cases, a user needs to call for or visit a repairman if he needs to remove a recording medium out of the image photographing apparatus, because it requires expert processes like disassembling the entire outer casing and working on the locking unit to unlock the recording medium cover manually.

The problem can be more serious if a repairman inadvertently touches interior components while working on the disassembling of the external casing. After the external casing is removed, components inside the image photographing apparatus are also exposed to potential dangers from the outside.

### SUMMARY OF THE INVENTION

The present general inventive concept provides an image photographing apparatus that is easy to use, as it provides emergency ejecting during an emergency, like when a battery is discharged or is disconnected from an external power source.

The present general inventive concept also provides an image photographing apparatus which exposes a recording medium cover locking unit to be opened manually by hand, instead of requiring any expert repair or manipulation of the entire internal structure of the image photographing apparatus, thereby preventing damage to internal components.

Additional aspects and utilities of the present general inventive concept will be set forth in part in the description which follows and, in part, will be obvious from the description, or may be learned by practice of the general inventive concept.

The foregoing and other aspects and utilities of the present general inventive concept may be achieved by providing an image photographing apparatus, including a main body including a lens unit, and a recording medium driving unit to control a recording medium that records an image photographed through the lens unit, a recording medium cover openably attached to the main body of the image photographing apparatus to insert or to remove the recording medium to or from the recording medium driving unit, a locking unit to lock or unlock the recording medium cover to or from the main body, and an opening unit detachably attached to the main body of the image photographing apparatus to expose the locking unit.

The recording medium cover may be pivotally opened and closed around a front portion of the main body in proximity to the lens unit, and the locking unit is disposed on a rear side of the main body.

The main body of the image photographing apparatus may house therein the lens unit, the recording medium driving unit, the locking unit, and a main and a sub circuit board to control the lens unit, the recording medium driving unit and the locking unit, the main body includes a casing having an opening disposed at a portion of the casing that corresponds to the position of the locking unit, and wherein the opening unit includes a cover member detachably engaged with the opening of the casing to cover the opening of the casing.

The sub circuit board may include a power switch, a mode selection switch, a playback switch and a plurality of light emitting elements, and the opening unit may further include a button unit to operate the switches. The button unit may be supported by the cover member.

The button unit may be implemented as a dual button structure that may include a holder housing, a power button disposed on the holder housing to operate the power switch, a first mode selection button and a first playback button disposed on the holder housing, and a second mode selection button and a second playback button to transfer an operating force of the first mode selection button and of the first playback button respectively to the mode selection switch and to the playback switch on the sub circuit board such that the second mode selection button and the second playback button are disposed on the holder housing.

The holder housing may further include a power button support to support the power button, and indicator supports to support a plurality of indicators that guide beams of light emitted from the light emitting elements of the sub circuit board towards the cover member.

The cover member may include a plurality of button exposure openings to expose the first mode selection button, the first playback button and the power button, and a plurality of indicator exposure openings to expose the indicators.

The plurality of buttons, the holder housing and the cover member may be made of plastic. A portion of the first mode selection button and a portion of the first playback button exposed outside the surface of the cover member may be plated with gold.

The cover member may be attached to the casing by a plurality of screws to cover the opening of the casing. Alternatively, one end of the cover member may be hinged to the casing, and the other end may be hooked to the casing.

The foregoing and other aspects and utilities of the present general inventive concept may also be achieved by providing an image photographing apparatus, including a main body including a lens unit, and a recording medium driving unit to control a recording medium to record an image photographed through the lens unit, and a main circuit board to process signals associated with the photographed image, a recording medium cover openably attached to the main body of the image photographing apparatus, a locking unit to lock or to unlock the recording medium cover, and an opening unit including a plurality of operating buttons to control the main circuit board, and is detachably attached to the main body of the image photographing apparatus to permit access to the locking unit to manually operate the locking unit.

At least one of the plurality of operating buttons of the opening unit may have a dual button structure. A playback button and a mode selection button of the opening unit may have a dual button structure.

The image photographing apparatus may also include a sub circuit board to process operation signals from the operating buttons, the sub circuit board being electrically connected to a main circuit board. The sub circuit board may include at least one operating switch connected to the operating buttons.

The recording medium of the image photographing apparatus may be a recording disk.

The foregoing and other aspects and utilities of the present general inventive concept may also be achieved by providing an image photographing apparatus, including a main body having a lens unit and a unit to control the lens unit and a recording medium, a recording medium cover attached to the main body to be in an open and a closed position, a locking unit to lock and to unlock the recording medium cover to and from the main body, and an opening unit detachably attached to the main body to cover an opening in the main body when attached to the main body and to provide access to the locking unit through the opening when detached from the main body.

The opening unit may include a plurality of buttons disposed in a dual button structure to control switches of the opening unit.

The plurality of buttons and the opening unit may be formed in a single body to be detached from the main body.

The switches of the opening unit may be accessed through the opening when the opening unit is detached from the main body.

The main body of the image photographing device may include a button to control the locking unit, and the locking unit may be controlled by the button when the opening unit is attached to the main body and may be manually controlled through the opening when the opening unit is detached from the main body.

The locking unit may be manually operable through the opening only in a no-power mode.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a perspective view illustrating an image photographing apparatus on which a recording medium cover is in an open state according to an exemplary embodiment of the present general inventive concept;

FIG. 2 is a perspective view illustrating an image photographing apparatus having a manual opening unit in an open state and having a recording medium cover capable of being opened by hand according to an exemplary embodiment of the present general inventive concept;

FIG. 3 is a perspective view illustrating a main part of an image photographing apparatus having a manual opening unit in an open state according to an exemplary embodiment of the present general inventive concept;

FIG. 4 is a perspective view illustrating a recording medium cover locking unit of an image photographing apparatus according to an exemplary embodiment of the present general inventive concept;

FIG. 5 is a perspective view of a manual opening unit of an image photographing apparatus according to an exemplary embodiment of the present general inventive concept;

FIG. 6 is a rear perspective view of the manual opening unit of FIG. 5;

FIG. 7 is an exploded perspective view of a manual opening unit of an image photographing apparatus according to an exemplary embodiment of the present general inventive concept;

FIG. 8 is a perspective view illustrating a holder of the manual opening unit of FIG. 7 along with adjacent components;

FIG. 9 is a view to illustrate the structure and operation of a dual-button structure provided in an embodiment of the manual opening unit of an image photographing apparatus according to an exemplary embodiment of the present general inventive concept; and

FIG. 10 is a block diagram of an embodiment of the interior of an image photographing apparatus according to an exemplary embodiment of the present general inventive concept.

### DETAILED DESCRIPTION OF THE PREFERRED EMBODIMENTS

Reference will now be made in detail to embodiments of the present general inventive concept, examples of which are illustrated in the accompanying drawings, wherein like reference numerals refer to the like elements throughout. The embodiments are described below in order to explain the present general inventive concept by referring to the figures.

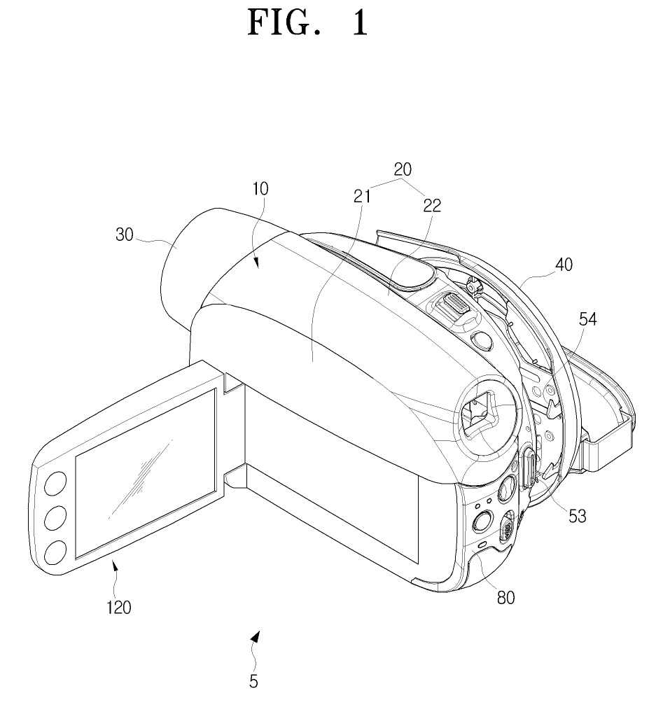

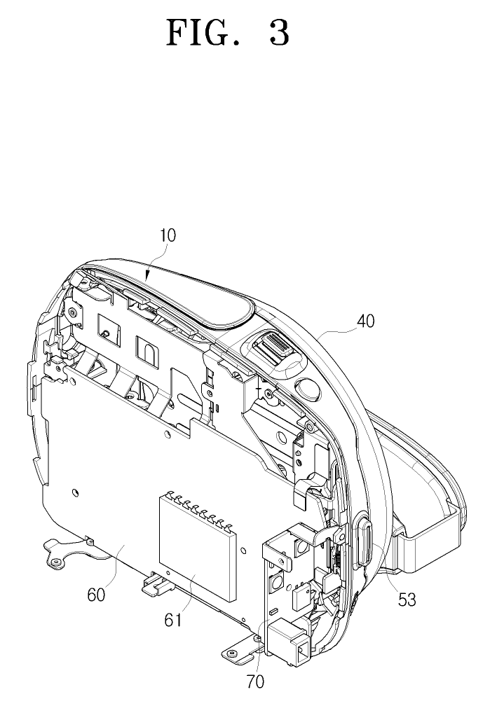

Referring to FIGS. 1 to 4, a main body 10 of an image forming apparatus 5, such as an image photographing apparatus, includes a casing 20. The casing 20 includes first and second casing members 21 and 22 to be engaged with each other. The casing 20 houses therein a lens unit 30 to photograph an object, and a recording medium driving unit (not illustrated) to drive a recording medium that writes the image photographed through the lens unit 30 on the recording medium. Although a DVD disk may be desirably used in one embodiment as the recording medium, it is possible that other forms of recording media disk types such as a CD or a Blue Ray Disk (BD), can also be used, as long as it has a large memory capacity.

The recording medium cover 40 is openably attached to the main body 10 of the image photographing apparatus 5 to allow a user to insert and to remove a recording medium to and from the recording medium driving unit (not illustrated). The recording medium cover 40 is capable of being opened about a pivot (not illustrated) located on a front side of the main body 10 where the lens unit 30 is located. In this embodiment, the recording medium is inserted or removed perpendicular with respect to a rear side of the main body 10 of the image photographing apparatus 5. Alternatively, the recording medium cover 40 may open about a pivot (not illustrated) located on a lower side of the main body 10, and the recording medium may be inserted or removed perpendicular with respect to an upper side of the main body 10.

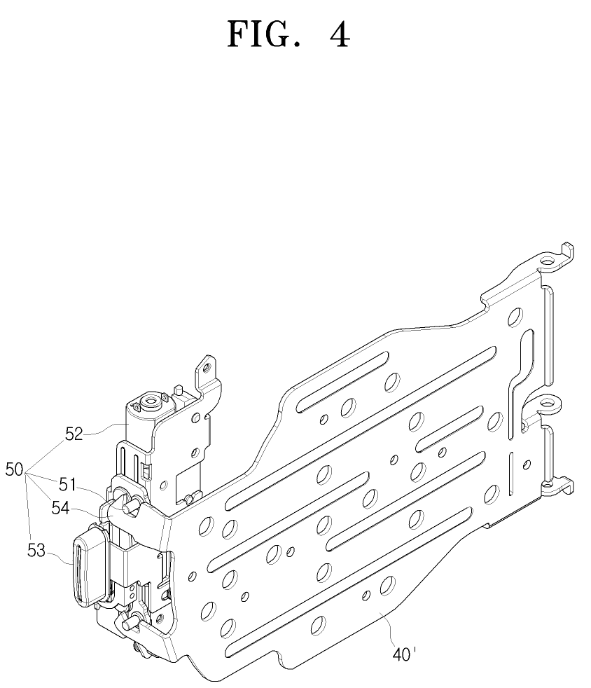

Referring to FIG. 4, in one embodiment a locking unit 50 is provided on the rear side of the main body 10 to lock or unlock the recording medium cover 40 to or from the main body 10 of the image photographing apparatus 5. Although FIG. 4 illustrates a frame 40′ that supports the recording medium cover 40, in a broader sense, the frame 40′ can be considered to be a substantial equivalent of the recording medium cover 40 which is attached to an outer surface of frame 40′. The locking unit 50 includes a lever 51 to lock a hook 54 provided on the recording medium cover frame 40′, a driving unit 52 such as a solenoid or an electrically driven motor to move the lever 51 to a locking position and an unlocking position, and an eject button 53 to initiate the driving unit 52.

The recording medium cover 40 is elastically biased in an opening direction, allowing it to open easily, and the locking lever 51 is elastically biased in a direction to lock the recording medium cover 40 in a closed position. Accordingly, in response to the pressing of the eject button 53 by a user, the locking lever 51 moves to the unlocking position, thereby opening the recording medium cover 40. The driving unit 52 is driven to move the locking lever 51 to the unlocking position. The driving unit 52 moves the locking lever 51 to the unlocking position after a predetermined amount of time from the pressing of the eject button 53 to give sufficient time for the rotating recording medium to come to a complete stop. As a result, the recording medium can be removed safely.

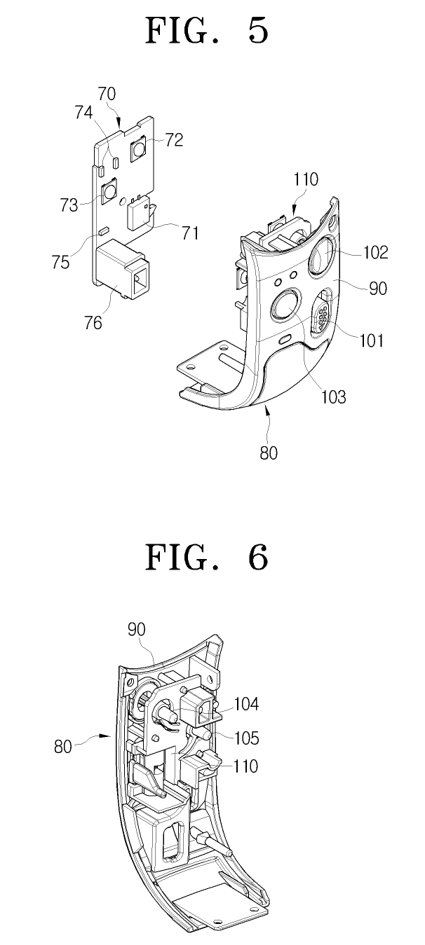

The casing 20 also houses therein a main circuit board 60 and a sub circuit board 70 to control the driving of the lens unit 30, the recording medium driving unit, and the locking unit 50. The casing 20 also has an opening 23 formed at a rear side of the casing 20 where the locking unit 50 is located. Through the opening 23, a user may operate the locking unit 50 inside the casing 20 manually with his hand. The sub circuit board 70 is mounted perpendicular to, and is connected electrically to, the main circuit board 60. The main circuit board 60 has mounted thereon a plurality of elements including a main chip 61. The sub circuit board 70 has mounted thereon, referring to FIG. 5, elements including a power switch 71, a mode selection switch 72, a playback switch 73, and a plurality of light emitting elements 74, 75.

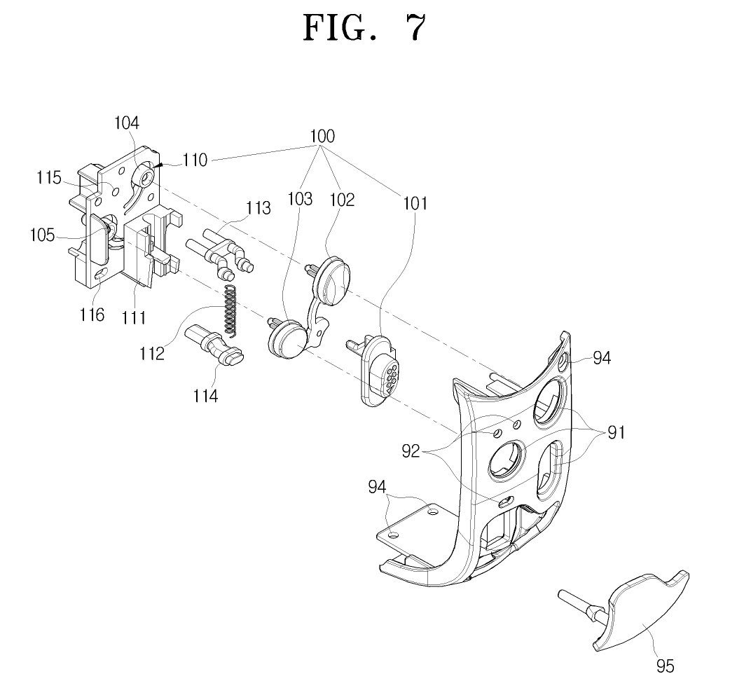

A manual opening unit 80 is removably engaged with the opening 23 of the casing 20 by a fastening means such as a plurality of screws 24. Accordingly, in one embodiment, a user simply unfastens several screws 24 from a corresponding support of the casing 20 to unlock the manual opening unit 80 to thus expose the locking unit 50 and to remove the recording medium, in the event of an emergency “no power” situation, such as a discharged battery. That is, a user can detach the manual opening unit 80 from the casing 20 to access the locking unit 50 through the opening 23 so that the recording medium cover 40 can be manually opened by a user to manually manipulate the locking unit 50. Referring to FIG. 7, the manual opening unit 80 has one or more holes 94, and the casing 20 has another corresponding one or more holes 94a, so that the screws 24 are coupled to the casing 20 through the holes 94 and 94a.

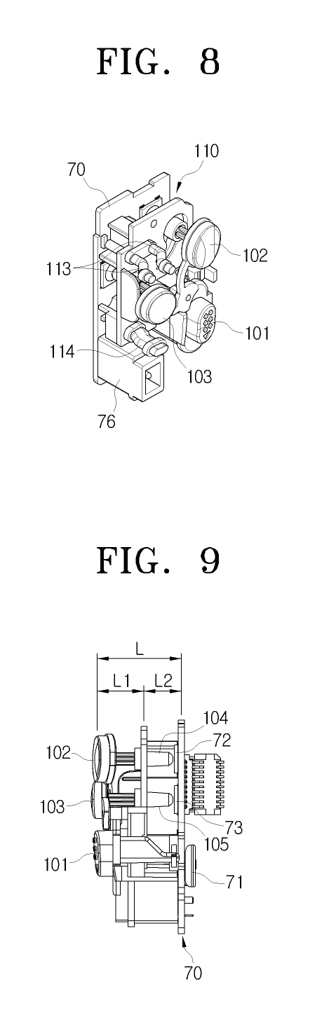

Referring to FIGS. 6 to 8, the manual opening unit 80 includes a cover member 90 sized to correspond and fit the opening 23 of the casing 20, and a button unit 100 supported by the cover member 90 to operate a plurality of switches 71, 72, 73 arranged on the sub circuit board 70.

When the cover member 90 is detached from the casing 20, switches 71, 72, and 73 can be accessed and operated through the opening 23.

The button unit 100 includes a power button 101 to operate the power switch 71, and a dual button structure to operate the mode selection switch 72 and the playback switch 73. The dual button structure includes a first mode selection button 102, a first playback button 103, a second mode selection button 104 to transmit an operating force of the first mode selection button 102 to the mode selection switch 72, and a second playback button 105 to transmit an operating force of the first playback button 103 to the playback switch 73.

The second mode selection button 104 and the second playback button 105 are provided on a holder 110. The first mode selection button 102 and the first playback button 103 are also supported by the holder 110 so as to operate in association with the second mode selection button 104 and the second playback button 105.

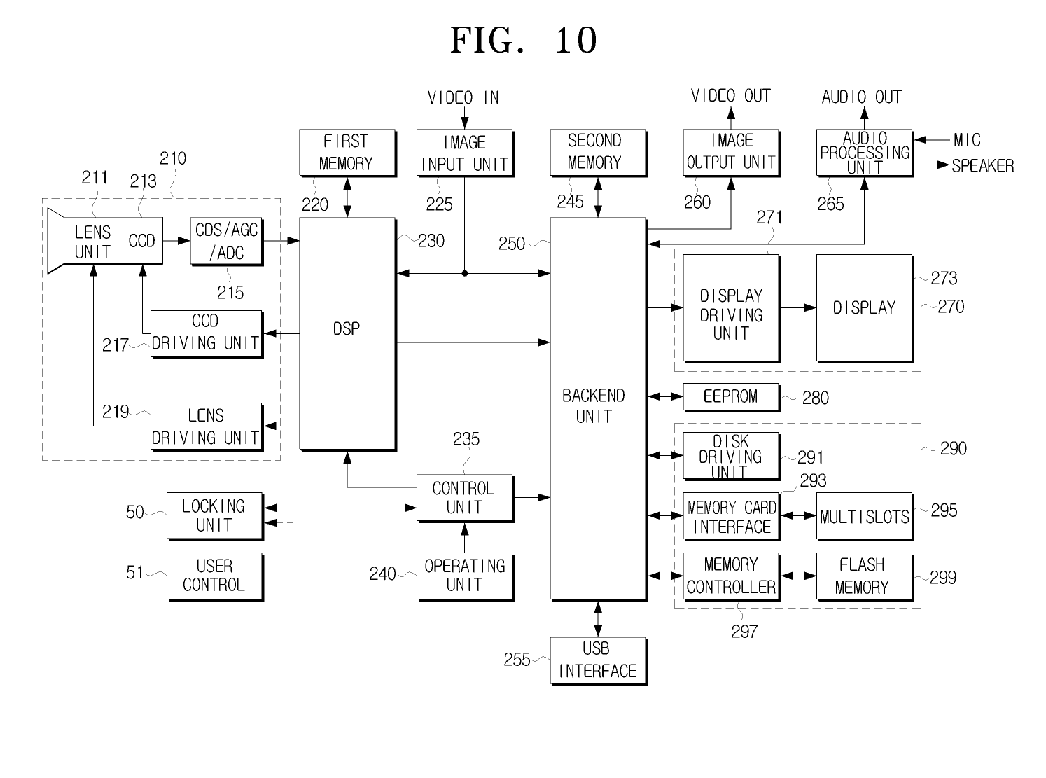

FIG. 9 is provided to explain the dual button structure and the operation thereof according to an exemplary embodiment of the present general inventive concept.

Referring to FIG. 9, the image photographing apparatus 5 has a long operation distance L of the buttons 101-103, that is the buttons 101-103 must travel a distance L to make contact with corresponding elements on sub circuit board 70, because the sub circuit board 70 and the cover member 90 are a relatively long distance away from each other. If one of the buttons 101-103 directly presses a corresponding switch on the sub circuit board 70, a user can have an uncomfortable feeling when pressing the switch which depress inward a relatively long distance, or even worse, have incorrect switching occur, due to an eccentric operation of a switch contact part caused by the operating angle of the button as it travels the operation distance L.

In order to prevent the above problems, an exemplary embodiment of the present general inventive concept provides a dual button structure that includes the first and second mode selection buttons 102 and 104, to operate the mode selection switch 72. According to this exemplary embodiment, an operation of pressing on a button is split into two stages. Because the operation distance of each of these two stages (L1 and L2) is approximately one-half of the operating length L of a single button (L1=½L, and L2=½L), an eccentric rotation is prevented in the switch contact part, and accordingly, an uncomfortable feeling of depressing a switch over such a relatively long distance, or incorrect operation of a switch from incorrect switching, can be prevented.

Additionally, the first mode selection button 102 disposed on an outer side of the manual opening unit 80 may be plated so as to provide a more elegant design, while the second mode selection button 104 may be hidden inside the manual opening unit 80 and is not plated to prevent static-related problems that may accompany a plated button. The plating may be a metal plating.

In a non-dual button structure, a button may be formed by a double injection process, or be partially plated to prevent static-related problems. However, the former involves an almost doubled injection cost, and the latter needs a separate processing and subsequent material cost to ensure that the button is partially plated. An exemplary embodiment of the present general inventive concept provides an efficient dual button structure, because the dual button structure can be plated in a simple and low-cost known manner.

The playback button to operate the playback switch 73 may also adopt a dual button structure as the mode selecting buttons 102, 104, explained above.

Referring to FIG. 7, the holder 110 includes a power button support 111 to support the power button 101. The power button 101 is movable in an upward and downward direction due to a spring 112 disposed at the power button support 111. Accordingly, the depressing of the power button 101 activates the power switch 71 disposed on the sub circuit board 70. The holder 110 may also include indicator supports 115, 116 to support indicators 113, 114 that guide beams of light irradiated from the light emitting elements 74, 75 of the sub circuit board 70 towards the cover member 90.

The button unit 100 may be detachably attached to the manual opening unit 80 to correspond to the sub circuit board 70 and may be detached from the casing 20 along with the manual opening unit 80. It is possible that the button unit 100 may be mounted on the casing 20 to correspond to the sub circuit board 70 and may be separated from the manual opening unit 80 when the manual opening unit 80 is detached from the casing 20 to provide an access passage to the locking unit 50 through the opening 23.

The cover member 90 includes a plurality of exposure holes 91 to expose various elements, including the power button 71, the first mode selection button 102, and the first playback button 103, and includes a plurality of indicator exposure holes 92 to expose the indicators 113, 114. The cover member 90 may also include a plurality of screw holes 94 to fasten the screws 24 and as a result, to fasten the cover member 90 to the casing 20. The cover member 90 may be made from the same material as the casing 20, such as plastic. The buttons and the holders may be made by a plastic molding process.

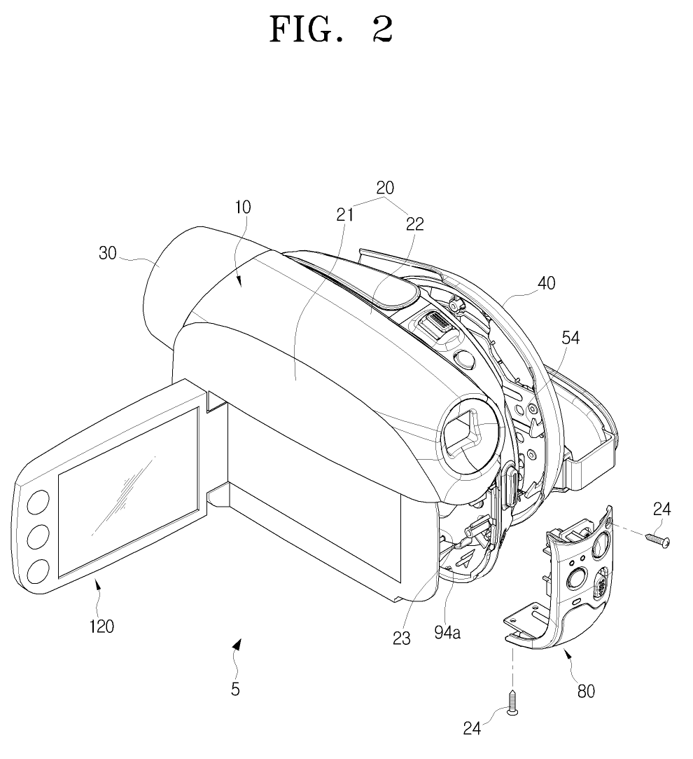

FIGS. 1 and 2 illustrate a display unit 120. On the display unit 120, a user may view an object being photographed through the lens unit 30. The user may also view the playback of the photographed images written on the recording medium on the display unit 120. FIG. 5 illustrates a power jack 76. A space to expose the power jack 76 is provided in the cover member 90. The space is covered by a moveable door 95 (refer to FIG. 7). The door 95 may be opened by a user to make a connection to the power jack 76 from an external power source (not illustrated).

Although an exemplary embodiment provides the cover member 90 being separably fastened over the opening 23 of the casing 20 by the screws 24, one will understand that other embodiments are possible. For example, in another embodiment one end of the cover member 90 may be hinged to the casing 20 and another end may be hooked to the casing 20 to securely close the cover member 90.

FIG. 10 is a block diagram illustrating an image photographing apparatus 5 according to an exemplary embodiment of the present general inventive concept.

Referring to FIG. 10, the photographing apparatus 5 according to an exemplary embodiment of the present general inventive concept includes a photographing unit 210, a first memory 220, an image input unit 225, a digital signal processor (DSP) 230, a control unit 235, an operating unit 240, a second memory 245, a backend unit 250, a USB interface 255, an image output unit 260, an audio processing unit 265, a display unit 270, an Electrically Erasable and Programmable Read Only Memory (EEPROM) 280, and a recording unit 290.

The photographing unit 210 photo-electrically converts an optical signal entering through a lens, and processes the electric signal. To this end, the photographing unit 210 includes a lens unit 211, a charge coupled device (CCD) 213, a Correlated Double Sampler/Auto Gain Controller/Analog-to-Digital converter (CDS/AGC/ADC) 215, a CCD driving unit 217, and a lens driving unit 219.

The lens unit 211 converges an optical image of an object being photographed onto an optical surface of the CCD 213. In one embodiment, the lens unit 211 corresponds to the lens unit 30 illustrated in FIGS. 1 and 2.

The lens driving unit 219 operates the lens unit 211. That is, the lens driving unit 219 performs a zoom-in or zoom-out movement of the lens unit 211 by operating a zoom-motor (not illustrated), adjusts a focal point by operating the lens unit 211 with a focus-motor (not illustrated), and adjusts degrees of opening of an iris (not illustrated) of the lens unit 211 by operating an iris-motor (not illustrated).

The CCD 213 is one of photographing elements which is driven by the CCD driving unit 217 to generate an electrical signal that corresponds to the optical image converged on the optical surface by the lens unit 211.

The CDS/AGC/ADC 217 performs processing of the electric signal output from the CCD 215, such as correlated double sampling, auto gain controlling, and A/D conversion.

The first memory 220 is a buffer to provide a recording space for the processing of image signals. The first memory 220 may be implemented as a flash memory and/or a Synchronous Dynamic Random Access Memory (SDRAM).

The image input unit 225 receives an image from an external device (not illustrated) and transfers the received image to the DSP 230 and/or backend unit 250.

The DSP 230 is an element that processes the signal of an image input from an output of the photographing unit 210 or of the image input unit 225. The DSP 230 uses the first memory 220 as a buffer to perform signal processing. That is, the DSP 230 performs digital zoom to convert the format of an image signal being output from the photographing unit 210 and to adjust the scale of an image, performs processing such as Auto White Balance (AWB), and outputs the processed signal to the backend unit 250. The DSP 230 also controls the lens driving unit 219 to perform processing such as Auto Focus (AF), or Auto Exposure (AE). The DSP 230 also compresses the image signal being output from the photographing unit 210 into a format, such as JPEG format, that is suitable for a still image, and outputs the compressed signal to the backend unit 250. The DSP 230 also de-compresses a formatted file being input to the backend unit 250 and outputs a generated image signal to the backend unit 250.

The control unit 235 controls the signal processing and transfer functions of the DSP 230 and the signal processing and transfer functions of the backend unit 250 according to user commands input through the operating unit 240.

In one embodiment, the operating unit 240 includes first and second photographing buttons, first and second zoom buttons, a display button, an easy Q button, a mode selection button, a power button, a Q check button and a copy button.

The second memory 245 is a buffer to provide a recording space for the signal processing of the backend unit 250. The second memory 245 also stores therein graphics, menus, or texts for the backend unit 250 to process On-Screen Display (OSD) signals. The second memory 245 may be implemented as a flash memory and/or SDRAM.

The backend unit 250 is an element to process signals related to an image and/or audio compression, de-compression, or playback. The backend unit 250 encodes an image signal being input from the DSP 230 to a format suitable for display, and outputs the encoded signal to the display unit 270 or the image output unit 260.

The backend unit 250 may process OSD signals for graphics, menus, or texts in association with the image signal being input from the DSP 230, and outputs the result. In particular, the backend unit 250 reads out OSD signal information for graphics, menus or texts from the second memory 245 to use the read OSD signal information in OSD processing.

The backend unit 250 compresses an image signal being input from the DSP 230, and an audio signal being input from the MIC input of the audio processing unit 265, and transfers the resultant compressed file to the recording unit 290. The backend unit 250 de-compresses a compressed file being input from the recording unit 290 to recover separate image and audio signals, and outputs the recovered image signal to the display unit 270, and/or outputs the recovered audio signal to the audio processing unit 265.

The backend unit 250 may OSD-process (i.e., process OSD signals) the recovered image signal when outputting the recovered image signal to the display unit 270. The backend unit 250 may transfer a formatted (for example, JPEG format) image signal being input from the DSP 230 to the recording unit 290, and may transfer a formatted file being input from the recording unit 290 to the DSP 230.

The USB interface 255 provides Universal Serial Bus (USB) formatted communication interface between USB devices, such as PC, a printer, or a digital camcorder. The image output unit 260 may output an image signal being output from the backend unit 250 to a connected external device such as a television set (TV).

The audio processing unit 265 provides an analog-to-digital conversion to convert an analog audio signal being input through an audio input element such as a microphone into a digital form, and transfers the converted digital signal to the backend unit 250. The audio processing unit 265 also converts a digital audio signal being output from the backend unit 250 into an analog audio signal, and outputs the converted analog signal to a connected external device such as a speaker.

The display unit 270 displays an image signal being output from the backend unit 250 on a display element such as a Liquid Crystal Display (LCD). The display unit 270 may include a display 273 which is operated by the display driving unit 271 to display an image. The display 273 corresponds to the display unit 120 illustrated in FIGS. 1 and 2.

The EEPROM 280 is a memory that stores programs and data for the signal processing and transfer operations of the backend unit 250.

The recording unit 290 records a compressed file being output from the backend unit 250 onto a recording medium. The recording unit 290 includes a disk driving unit 291, a memory card interface 293, multislots 295, a memory controller 297, and a flash memory 299.

The disk driving unit 291 may write a compressed file being input from the backend unit 250 on a disk. The disk driving unit 291 may also read out a compressed file from the disk and output it to the backend unit 250. The disk may be a Compact Disk (CD), a Digital Versatile Disk (DVD), a Blue-ray Disk (BD), or a High Definition-DVD (HD-DVD).

The memory card interface 293 may also write a compressed file being input from the backend unit 250 onto any of a variety of memory cards insertable by a user in the multislots 293. The memory card interface 293 may also read out a compressed file from any of a variety of memory cards and output it to the backend unit 250. The memory card is insertable into and removable from the image photographing apparatus 5 by a user and may be a multimedia card (MMC), a secure digital (SD) card, or the like.

The memory controller 297 may also record a compressed file being input from the backend unit 250 onto a flash memory 299. The flash memory 299 may be internal or removable. The memory controller 297 may read out a compressed file from the flash memory 299 and output it to the backend unit 250.

The control unit 235 controls the backend unit 250 and the recording unit 290 so that a compressed file being output from the backend unit 250 is written to at least one of the disk, the memory card, and the flash memory 299. A user may select a recording medium to use through the OSD menus provided by the backend unit 250.

The control unit 235 controls file copy operations among the internal or removable recording media inserted in the recording unit 290. That is, the control unit 235 controls the processing that includes: i) copying a file from the flash memory 299 onto a disk or a memory card; ii) copying a file from a memory card onto a disk or the flash memory 299; and iii) copying a file from a disk onto a memory card or the flash memory 299. A user may set one of the above copying operations from the menu that is provided by the OSD processing of the backend unit 250.

The copying operations: (i) accompany either a process, a) in which a file read from the flash memory 299 by the memory controller 297 is copied onto a disk by the backend unit 250 and the disk driving unit 291, or b) in which a file read from the flash memory 299 by the memory controller 297 is copied onto a memory card through the multislots 295 by the backend unit 250 and the memory card interface 293.

The copying operations: (ii) accompany either a process, a) in which a file read from a memory card by the memory card interface 293 through the multislots 295 is copied onto a disk by the backend unit 250 and the disk driving unit 291, or b) in which a file read from a memory card by the memory card interface 293 through the multislots 295 is copied onto the flash memory 299 by the backend unit 250 and the memory controller 297.

The copying operations: (iii) accompany either a process, a) in which a file read from a disk by the disk driving unit 291 is copied onto the memory card through the multislots 295 by the backend unit 250 and the memory card interface 293, or b) in which a file read from a disk by the disk driving unit 291 is copied onto the flash memory 299 by the backend unit 250 and the memory controller 297.

A photographer using an image photographing apparatus 5 constructed according to an exemplary embodiment of the present general inventive concept, opens the recording medium cover 40, inserts a recording medium, and photographs an object. An internal battery or an external power source (not illustrated) may be used to power the image photographing apparatus 5. The photographer continues photographing the object, while viewing the photographed image through the display unit 120.

If it is necessary to replace a recording medium during a photographing session, the photographer operates the eject button 53 provided at the rear side of the main body 10 (see FIG. 1). The locking lever 51 is moved to an unlocking position by the driving unit 52 (FIG. 4) of the image photographing apparatus 5 when a predetermined amount of time elapses, to thereby unlock and open the recording medium cover 40. The photographer replaces the recording medium, and with the closing of the recording medium cover 40, the recording medium cover 40 is locked securely.

The photographer is unable to open the recording medium cover 40 by simply operating the eject button 53 when the camera battery has discharged or when a connection to an external power source is unavailable. In such a case, the photographer may disengage the manual opening unit 80 from the rear part of the main body 10 to expose the locking unit 50 placed therein. The photographer simply needs to unfasten several screws 24 to separate the manual opening unit 80 from the main body 10.

As illustrated in FIG. 10, the locking unit 50 of the image photographing apparatus 5 is controlled by the control unit 235 during normal operation and by a user control 51 through the opening 23 during manual operation, such as the “no power” situation, when the manual opening unit 80 is detached from the casing 20 by a user.

Since the inside of the main body 10 is then exposed through the opening 23 of the main body 10 after disengaging the manual opening unit 80 from the main body 10, the photographer is able to manually operate the locking lever 51 of the locking unit 50 with his hand to unlock the recording medium cover 40 in order to extract the recording medium disposed therein.

As explained above, in a “no power” situation when the camera battery is discharged or connection to an external power source is unavailable, a photographer simply disengages the manual opening unit 80 from the main body 10 of the image photographing apparatus 5 to expose the locking unit 50 to the outside, open the recording medium cover 40, and remove the recording medium. According to this exemplary embodiment, an ordinary person can replace a recording medium without requiring an expert's knowledge of the electronics and the mechanics, and there is minimal risk of damaging other components since there is no need to disassemble the entire casing of the main body 10 in order to extract the recording medium.

That is, user convenience improves because an ordinary user can open the recording medium cover by simply disengaging the open unit from the main body of the image photographing apparatus even when the battery has discharged or when a connection to an external power source is unavailable.

Furthermore, damage to internal components can be avoided because it is unnecessary to disassemble the entire casing of the main body to conduct an “emergency ejecting” of a recording medium (that is, in the event of a battery discharge or the unavailability of an external power source).

Although a few embodiments of the present general inventive concept have been illustrated and described, it will be appreciated by those skilled in the art that changes may be made in these embodiments without departing from the principles and spirit of the general inventive concept, the scope of which is defined in the appended claims and their equivalents.

What is claimed is:

1. An image photographing apparatus, comprising:
a main body comprising a lens unit, and a recording medium driving unit to control a recording medium that records an image photographed through the lens unit;
a recording medium cover openably attached to the main body of the image photographing apparatus to insert or to remove a recording medium to or from the recording medium driving unit;
a locking unit to lock or unlock the recording medium cover to or from the main body; and
an opening unit detachably attached to the main body of the image photographing apparatus to expose the locking unit.

2. The image photographing apparatus of claim 1, wherein the recording medium cover is pivotally opened and closed around a front portion of the main body in proximity to the lens unit, and the locking unit is disposed on a rear side of the main body.

3. The image photographing apparatus of claim 1, wherein:
the main body of the image photographing apparatus houses therein the lens unit, the recording medium driving unit, the locking unit, and a main and a sub circuit board to control the lens unit, the recording medium driving unit and the locking unit:
the main body comprises a casing having an opening disposed at a portion of the casing that corresponds to the position of the locking unit: and
the opening unit comprises a cover member detachably engaged with the opening of the casing to cover the opening of the casing.

4. The image photographing apparatus of claim 3, wherein:
the sub circuit board comprises a power switch, a mode selection switch, a playback switch and a plurality of light emitting elements: and
the opening unit further comprises a button unit to operate the switches.

5. The image photographing apparatus of claim 4, wherein the button unit is supported by the cover member.

6. The image photographing apparatus of claim 4, wherein the button unit is implemented as a dual button structure that comprises:
a holder housing;
a power button disposed on the holder housing to operate the power switch;
a first mode selection button and a first playback button disposed on the holder housing; and
a second mode selection button and a second playback button to transfer an operating force of the first mode selection button and of the first playback button respectively to the mode selection switch and to the playback switch on the sub circuit board such that the second mode selection button and the second playback button are disposed on the holder housing.

7. The image photographing apparatus of claim 6, wherein the holder housing comprises:
a power button support to support the power button; and
indicator supports to support a plurality of indicators that guide beams of light emitted from the light emitting elements of the sub circuit board towards the cover member.

8. The image photographing apparatus of claim 7, wherein the cover member comprises:
a plurality of button exposure openings to expose the first mode selection button, the first playback button and the power button; and
a plurality of indicator exposure openings to expose the indicators.

9. The image photographing apparatus of claim 6, wherein the plurality of buttons, the holder housing and the cover member are made of plastic.

10. The image photographing apparatus of claim 9, wherein a portion of the first mode selection button and a portion of the first playback button exposed outside the surface of the cover member are plated with gold.

11. The image photographing apparatus of claim 6, wherein the cover member is attached to the casing by a plurality of screws to cover the opening of the casing.

12. An image photographing apparatus, comprising:
a main body comprising a lens unit, and a recording medium driving unit to control a recording medium to record an image photographed through the lens unit, and a main circuit board to process signals associated with the photographed image;
a recording medium cover openably attached to the main body of the image photographing apparatus;
a locking unit to lock or to unlock the recording medium cover; and
an opening unit having a plurality of operating buttons to control the main circuit board, and is detachably attached to the main body of the image photographing apparatus to permit access to the locking unit to manually operate the locking unit.

13. The image photographing apparatus of claim 12, wherein at least one of the plurality of operating buttons comprises a dual button structure.

14. The image photographing apparatus of claim 13, wherein a playback button and a mode selection button of the opening unit have a dual button structure.

15. The image photographing apparatus of claim 12, further comprising:
a sub circuit board to process operation signals from the operating buttons, the sub circuit board being electrically connected to a main circuit board.

16. The image photographing apparatus of claim 15, wherein the sub circuit board comprises at least one operating switch connected to the operating buttons.

17. The image photographing apparatus of claim 1, wherein the recording medium is a recording disk.

18. An image photographing device, comprising:
a main body having a lens unit and a unit to control the lens unit and a recording medium;
a recording medium cover attached to the main body to be in an open and a closed position;
a locking unit to lock and to unlock the recording medium cover to and from the main body; and
an opening unit detachably attached to the main body to cover an opening in the main body when attached to the main body and to provide access to the locking unit through the opening when detached from the main body.

19. The image photographing device of claim 18, wherein the opening unit includes a plurality of buttons having a dual button structure to control switches of the opening unit.

20. The image photographing device of claim 19, wherein the plurality of buttons and the opening unit are formed in a single body to be detached from the main body.

21. The image photographing device of claim 19, wherein the switches of the opening unit can be accessed through the opening when the opening unit is detached from the main body.

22. The image photographing device of claim 18, wherein the main body comprises:
a button to control the locking unit, and the locking unit is controlled by the button when the opening unit is attached to the main body and is manually controlled through the opening when the opening unit is detached from the main body.

23. The image photographing device of claim 18, wherein the locking unit is manually operable through the opening only in a no-power mode.
